(19) United States
(12) Patent Application Publication
(10) Pub. No.: US 2020/0226506 A1
(43) Pub. Date: Jul. 16, 2020

(54) METHODS AND SYSTEMS FOR AUTOMATED SALESBEAT OPTIMIZATION

(71) Applicants: Shashank Srivastava, bangalore (IN); Rahul Jain, Gurgaon (IN); geet garg, Lucknow (IN); Manu A C, bangalore (IN); Aniket Uday Sawant, bangalore (IN); Arun Nalla, Hanamkonda (IN)

(72) Inventors: Shashank Srivastava, bangalore (IN); Rahul Jain, Gurgaon (IN); geet garg, Lucknow (IN); Manu A C, bangalore (IN); Aniket Uday Sawant, bangalore (IN); Arun Nalla, Hanamkonda (IN)

(21) Appl. No.: 16/684,575

(22) Filed: Nov. 14, 2019

Related U.S. Application Data
(60) Provisional application No. 62/767,118, filed on Nov. 14, 2018.
(60) Provisional application No. 62/935,624, filed on Nov. 14, 2019.

(51) Int. Cl. G06Q 10/04; G06Q 30/02

(52) U.S. Cl. CPC G06Q 10/047; G06Q 30/0244

(57) ABSTRACT

In one aspect, a computerized method of automated solution for periodic journey planning comprising includes the step of creating a set of salesbeats using a set of outlet data and a set of customer level data. The method includes the step of allocating each of the salesbeats to one or more sales executives. A salesbeat includes a plan that defines who to visit; when to visit; an identity of a sales executives to send and a day level route plan made for field sales/marketing personnel to make visits to a number of stores at a predefined frequency. The method includes the step of allocating the sales executives are allocated to a specified set of days. The method includes the step of implements sequencing of outlets within the salesbeats established using a capacitated vehicle routing problem (CVRP) algorithm such that a distance traveled and a time window of the salesbeat is optimized for the sales executives.

### CLAIM OF PRIORITY

This application claims priority to U.S. Provisional Patent Application No. 62/767,118 filed on Nov. 14, 2018 and titled. This application is hereby incorporated by reference in its entirety METHODS AND SYSTEMS FOR AUTOMATED SALESBEAT OPTIMIZATION.

This application claims priority to U.S. Provisional Patent Application No. 62/935,624 filed on 11-14-2019 and titled. This application is hereby incorporated by reference in its entirety METHODS AND SYSTEMS FOR AUTOMATED SALESBEAT OPTIMIZATION.

### BACKGROUND

One of the common motivations to employ a salesbeat journey plan is to maximize reach. Even though, the customers can be reached with a cheaper mode of sales, for example a telephonic call, the industry prefers to spend more to develop personal relationships with the customers and not miss sales. This is because the opportunity cost of missing a sale is much higher than just the profit from the sale. Another motivation for sales journey planning is to enroll new customers and discover new markets. Although, different industries may have slightly different objectives, the broad objective of a sales journey plan is to visit new and old customers at minimum cost and maximum serviceability ratio, respecting the respective business constraints. Accordingly, optimizations to sales journey planning systems and methods are desired.

### SUMMARY OF THE INVENTION

In one aspect, a computerized method of automated solution for periodic journey planning comprising includes the step of creating a set of salesbeats using a set of outlet data and a set of customer level data. The method includes the step of allocating each of the salesbeats to one or more sales executives. A salesbeat includes a plan that defines who to visit; when to visit; an identity of a sales executives to send and a day level route plan made for field sales/marketing personnel to make visits to a number of stores at a predefined frequency. The method includes the step of allocating the sales executives are allocated to a specified set of days. The method includes the step of implements sequencing of outlets within the salesbeats established using a capacitated vehicle routing problem (CVRP) algorithm such that a distance traveled and a time window of the salesbeat is optimized for the sales executives.

### BRIEF DESCRIPTION OF THE DRAWINGS

FIG. 1 illustrates an example system for implementing automated salesbeat optimization, according to some embodiments.

FIG. 2 depicts an exemplary computing system that can be configured to perform any one of the processes provided herein.

FIG. 3 is a block diagram of a sample computing environment that can be utilized to implement various embodiments.

FIG. 4 illustrates an example screenshot for implementing sales-journey planning, according to some embodiments.

FIG. 5 illustrates an example process for optimizing specified terms of a sales-journey planning process, according to some embodiments.

FIG. 6 illustrates an example process illustrating an example graph illustrating time of day vs. earning potential optimizations, according to some embodiments.

FIG. 7 illustrates an example process for implementing automated salesbeat optimization, according to some embodiments.

FIG. 8 illustrates an example process for implementing tour construction in an automated salesbeat optimization process, according to some embodiments.

FIG. 9 illustrates an example pseudocode for implementing tour construction in an automated salesbeat optimization process, according to some embodiments.

FIG. 10 illustrates an example process for generating a PJP Configuration, according to some embodiments.

FIG. 11 and FIGS. 12-15 illustrate an example process for PJP modelling, according to some embodiments.

FIG. 16 illustrates an example PJP planning screen shot, according to some embodiments.

FIG. 17 illustrates an example process for utilizing Mixed Integer Programming (MIP) for PJP, according to some embodiments.

The Figures described above are a representative set and are not an exhaustive with respect to embodying the invention.

### DESCRIPTION

Disclosed are a system, method, and article of manufacture for automated salesbeat optimization. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” ‘one example,’ or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Definitions

Example definitions for some embodiments are now provided.

Application programming interface (API) can specify how software components of various systems interact with each other.

Cloud computing can involve deploying groups of remote servers and/or software networks that allow centralized data storage and online access to computer services or resources. These groups of remote serves and/or software networks can be a collection of remote computing services.

CVRP stands for capacitated vehicle routing problem. In this problem, one has n tasks and k vehicles of c capacity each. Each task has a volume associated with it. The optimization process must assign each vehicle a subset of tasks, such that no task is done twice and the volume capacities of the vehicles are not breached. The optimization process minimizes total distance travelled. It can also have objective terms to minimize the number of vehicles used. Vehicles may or may not start and end from a central home base depending on the problem constraints.

Directed acyclic graph is a finite directed graph with no directed cycles. That is, it consists of finitely many vertices and edges, with each edge directed from one vertex to another, such that there is no way to start at any vertex v and follow a consistently-directed sequence of edges that eventually loops back to v again. A DAG can be a directed graph that has a topological ordering, a sequence of the vertices such that every edge is directed from earlier to later in the sequence.

Fleet management software (FMS) is computer software that enables people to accomplish a series of specific tasks in the management of any or all aspects relating to a fleet of vehicles operated by a company, government, or other organization. These specific tasks encompass various operations from vehicle acquisition through maintenance to disposal.

Fast-Moving Consumer Goods (FMCG) are products that are sold quickly and at a relatively low cost. The main characteristics of FMCG are as follows: fast moving products/frequently purchased; rapid consumption of products; low cost products; high volume products; low contribution products (e.g. profit contribution per product is usually small, etc.); short shelf life; high turnover; etc. It is noted that each FMCG brand can have its own specific criteria for segregating the FMCG goods they sell. An understanding of the priorities and requirements of these brand specific categorization can be utilized as well such that they may be integrated into a PJP planning module for determining optimized salesbeats.

Heuristic is a technique designed for solving a problem more quickly (e.g. when classic methods are too slow) or for finding an approximate solution (e.g. when classic methods fail to find any exact solution). This is achieved by trading optimality, completeness, accuracy, or precision for speed.

Mixed Integer Program (MIP) can be a mathematical programming technique where some variables need to be integers and the remaining can be floating point numbers.

PJP (e.g. salesbeat planning) is a day level route planning system implemented for sales personnel to visit multiple stores for the offline sales/marketing of FMCG products for a pre-set frequency. PJP employs a static planning methodology based on the parent company's priorities, or market requirements for that segment of the product. The frequency of generating such a static plan is dependent on client specifications (e.g. 3-6 months). A beat plan generated through PJP can highlight the following information, inter alia: whom to visit; when to visit; which salesperson to send based on the client's priorities for skills of salesperson/outlet; etc.

Salesbeat can be a plan that defines, inter alia: who to visit; when to visit; identity of salesperson to send based on company's priorities on stores category/segment; a permanent journey plan; day level route plan made for field sales/marketing personnel to make visits to a number of stores at a predefined frequency. It is noted, that in some examples, the salesbeat plans can be planned in advance (e.g. a month in advance). Salesbeat can include information regarding the following: order collection, visual merchandising, competitor analysis, etc.

Stock keeping unit (SKU) is a distinct type of item for sale, such as a product or service, and all attributes associated with the item type that distinguish it from other item types.

Travelling salesman problem (TSP) asks the following question: “Given a list of cities and the distances between each pair of cities, what is the shortest possible route that visits each city and returns to the origin city?”.

Example Embodiments

Sales fleet permanent journey planning is a standard practice for industries that utilize a push sales model. The decision-making process can involve assignment of a set of outlets/stores to salesperson to visit on a particular day. The job of the salesperson is to cover all outlets in the designated time and maximize sales. Sales-fleet management can include a number of automation solutions. These can include solutions for optimal assignment of salesperson to outlet today such that total costs are minimized, and revenues are maximized. Sales-fleet management can use, inter alia: mathematical programming, heuristic optimization and their integration with machine-learning models to create optimal journey plans.

Exemplary Systems

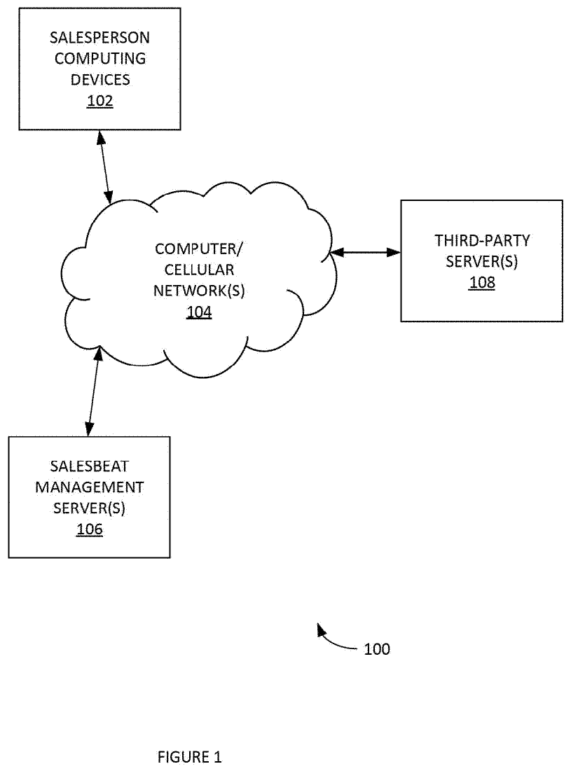

FIG. 1 illustrates an example system 100 for implementing automated salesbeat optimization, according to some embodiments.

Salesperson computing device(s) 102 can be mobile device(s), laptops, etc. that include an automated salesbeat optimization application (e.g. a sales-fleet management application). Salesperson computing device(s) 102 can communicate salesperson information (e.g. identity, location, location history, sales history, etc.) to salesbeat management server(s) 106.

Computer/Cellular networks 104 can include the Internet, text messaging networks (e.g. short messaging service (SMS) networks, multimedia messaging service (MMS) networks, proprietary messaging networks, instant messaging service networks, email systems, etc. Computer/Cellular networks 104 can include cellular networks, satellite networks, etc. Computer/Cellular networks 104 can be used to communicate messages and/or other information (e.g. videos, tests, articles, digital images, videos etc.) from the various entities of system 100.

Salesbeat management server(s) 106 can implement sales-fleet journey planning Salesbeat management server(s) 106 can assist entities that utilize a push business model (e.g. FMCG, pharmaceuticals, cement products, agricultural products, etc.). Salesbeat management server(s) 106 can manage sales fleet optimization.

Salesbeat management server(s) 106 can include functionalities to optimize the equation: min(Total costs) +max(revenue). Accordingly, Salesbeat management server(s) 106 can calculate the cost-function of vehicle routing. This can minimize total distance travelled. Salesbeat management server(s) 106 can determine numerous objective terms such as, inter alia: same day visit minimization (e.g. N-mirror), ideal spacing minimization (e.g. N+k mirror), salesmen fatigue minimization, revenue fairness across tours, visit fairness, higher salesperson-tour affinity, same day tour closeness, time on road minimization, reduction of contracted salesmen and reduction of salesmen. It is noted that additional details on the costs are provided infra (e.g. in process 500).

Salesbeat management server(s) 106 can include various other functionalities such as, inter alia: web servers, SMS servers, IM servers, chat bots, database system managers, e-commerce engines, geo-mapping functionalities, web mapping services, etc. Salesbeat management server(s) 106 can include manage a mobile-device application in both user-side computing device(s) 102.

Salesbeat management server(s) 106 can utilize machine learning techniques (e.g. artificial neural networks, etc.). Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alio: decision tree learning, association rule learning, artificial neural networks, inductive logic programming, support vector machines, clustering, Bayesian networks, reinforcement learning, representation learning, similarity and metric learning, and/or sparse dictionary learning.

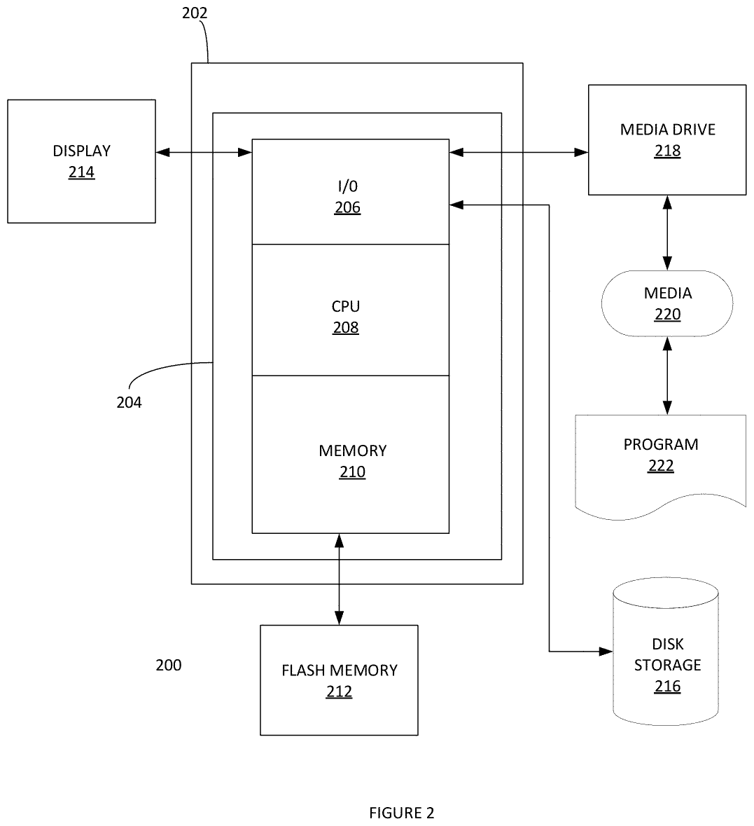

FIG. 2 depicts an exemplary computing system 200 that can be configured to perform any one of the processes provided herein. In this context, computing system 200 may include, for example, a processor, memory, storage, and I/O devices (e.g., monitor, keyboard, disk drive, Internet connection, etc.). However, computing system 200 may include circuitry or other specialized hardware for carrying out some or all aspects of the processes. In some operational settings, computing system 200 may be configured as a system that includes one or more units, each of which is configured to carry out some aspects of the processes either in software, hardware, or some combination thereof.

FIG. 2 depicts computing system 200 with a number of components that may be used to perform any of the processes described herein. The main system 202 includes a motherboard 204 having an I/O section 206, one or more central processing units (CPU) 208, and a memory section 210, which may have a flash memory card 212 related to it. The I/O section 206 can be connected to a display 214, a keyboard and/or other user input (not shown), a disk storage unit 216, and a media drive unit 218. The media drive unit 218 can read/write a computer-readable medium 220, which can contain programs 222 and/or data. Computing system 200 can include a web browser. Moreover, it is noted that computing system 200 can be configured to include additional systems in order to fulfill various functionalities. Computing system 200 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

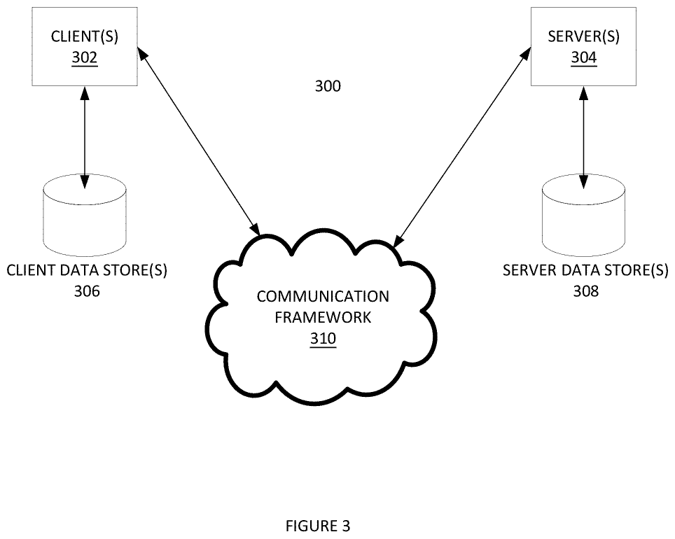

FIG. 3 is a block diagram of a sample computing environment 300 that can be utilized to implement various embodiments. The system 300 further illustrates a system that includes one or more client(s) 302. The client(s) 302 can be hardware and/or software (e.g., threads, processes, computing devices). The system 300 also includes one or more server(s) 304. The server(s) 304 can also be hardware and/or software (e.g., threads, processes, computing devices). One possible communication between a client 302 and a server 304 may be in the form of a data packet adapted to be transmitted between two or more computer processes. The system 300 includes a communication framework 310 that can be employed to facilitate communications between the client(s) 302 and the server(s) 304. The client(s) 302 are connected to one or more client data store(s) 306 that can be employed to store information local to the client(s) 302. Similarly, the server(s) 304 are connected to one or more server data store(s) 308 that can be employed to store information local to the server(s) 304. In some embodiments, system 300 can instead be a collection of remote computing services constituting a cloud-computing platform.

Exemplary Methods

The following methods/processes can be implemented by systems 100-300.

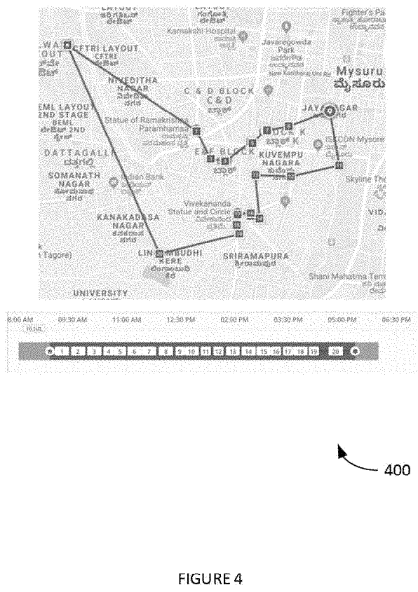

FIG. 4 illustrates an example screenshot 400 for implementing sales-journey planning, according to some embodiments.

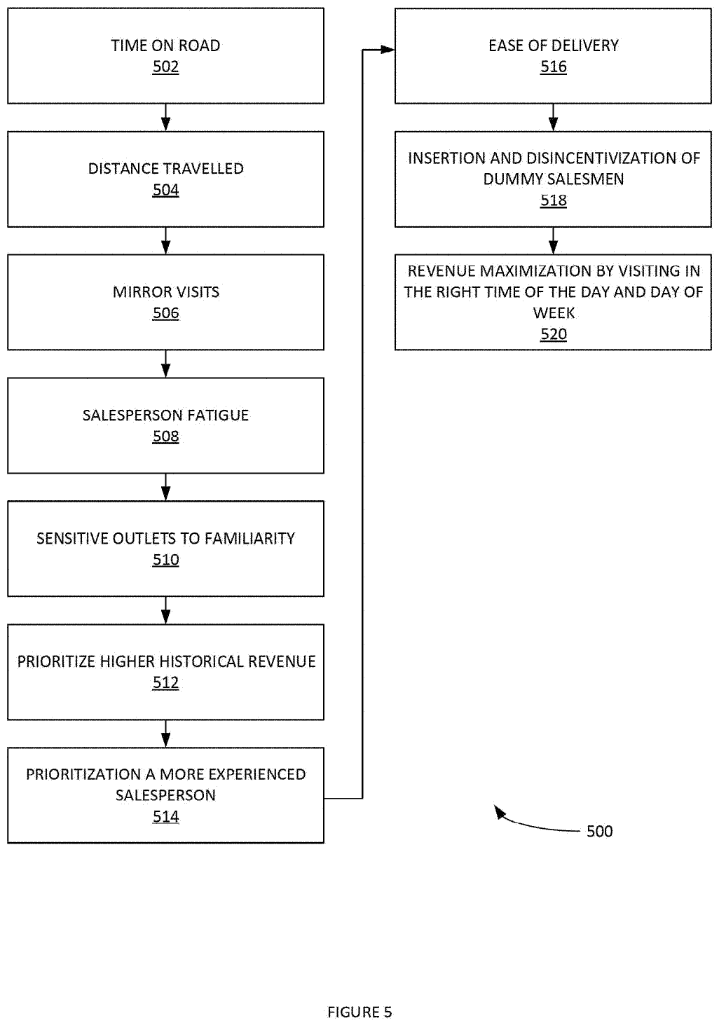

FIG. 5 illustrates an example process 500 for optimizing specified terms of a sales-journey planning process, according to some embodiments. The terms are now discussed.

In step 502, process 500 can optimize the salesperson's time on road term. Time on road can be an objective function used to increase the serviceability ratio. Process 500 can have an objective to maximize the time in store.

In step 504, process 500 can optimize the distance travelled term. Distance travelled can be an objective function that is a standard routing cost. Process 500 can seek to minimize the total travelled distance.

In step 506, process 500 can optimize the mirror visits term. Mirror visits involve scheduling more than one salesperson to a store in one day. Given that the customers have limited amount of resources on a given day, it is not beneficial to schedule more than one salesperson to a store in one day. Process 500 can seek to schedule visits spaced out by a 2-3 days for example. Process 500 can calculate a cost penalty for visiting a store more than once in k-days.

In step 508, process 500 can optimize the salesperson fatigue term. Salesperson fatigue involve the fact that, usually, as the day progresses, a salesperson becomes tired and a cost should be applied this state. Process 500 can incentivize visits to higher revenue stores during non-fatigued periods. Accordingly, a salesperson can be assigned higher revenue outlets during the most productive part of the salesperson.

In step 510, process 500 can optimize sensitive outlets to familiarity term. Sensitive outlets to familiarity can consider the fact that sales can depend upon the performance of the salesperson. Accordingly, one of the major factors is whether the shopkeeper is familiar with the salesperson visiting him. This familiarity forces a familiar salesperson to visit a shopkeeper with higher probability, controlled by a weight.

In step 512, process 500 can optimize prioritize higher historical revenue term. Prioritize higher historical revenue can consider the fact that sales may depend upon the performance of the salesperson. Accordingly, process 500 can optimize how much the salesperson has sold in the past among the outlets that he can now serve. A higher revenue salesperson can be allotted a beat with higher revenue controlled by a weight.

In step 514, process 500 can optimize the prioritize a more experienced salesperson term. As a lot of the sales depends upon the performance of the salesperson, process 500 can consider the factors of how many years of experience does a salesperson possess. This forces a more experienced salesperson to perform in a higher revenue context, and hence be more sensitive to a business, beat, controlled by a weight. It is noted that, in a multi-variate optimization function, the relative importance of any of the factors is given by the weight (e.g. a numerical number) to that term. If a particular client/customer needs more importance to be given to experience, then the numerical value of the weight can be increased. This can make the optimization routine flexible to different requirements of different clients.

In step 516, process 500 can optimize the ease of delivery term. In some examples, products of different kinds are delivered together (e.g. a day or two after collection of the orders). In such cases it is advantageous to have the beats of one delivery group close to each other than being far away as it will allow a single van to deliver to all the outlets and allow a geographical separation of deliveries across days in order to plan the deliveries with ease. It is noted that, beats, in this case can correspond to salesman tours on a particular day. Once the salesman tours are executed on a particular day, after k days deliveries for the orders collected are made to the stores. In such a case, it is advantageous to have salesman tours to be in the same vicinity to reduce delivery cost for the collected orders.

In step 518, process 500 can optimize the insertion and disincentivizing of dummy salesmen term. In some examples, the number of salespersons currently serving the set of customers are sufficient as, inter alia: either all outlets were not being served, calls instead of visits by salesmen, new outlets were added, transaction time required needed to be increased to increase sales, etc. In such cases, process 500 can suggest a number of dummy salesperson of each product to be added which the client can hire from the market or increase the workforce. Process 500 can use two (2) runs of the MIP program, one without the dummies to calculate number of dummies required by looking at the unassigned customers, and a second run to finally allocate the customers, to salesperson, to days. However, adding an excess of dummies is not advisable as the client would want to limit the number of dummies. This disincentivizing can be implemented using a weight.

In step 520, process 500 can optimize the revenue maximization by visiting in the right time of the day and day of week term. Process 500 can employ a ML framework to relate the time of visit in the day and the day of the week to expected revenue from the store. This can enable process 500 to differentiate between keeping a few customers in the beginning or end of the tours or during the beginning and the end of the week. A revenue curve to time curve can be used as an objective which incentivizes higher revenue.

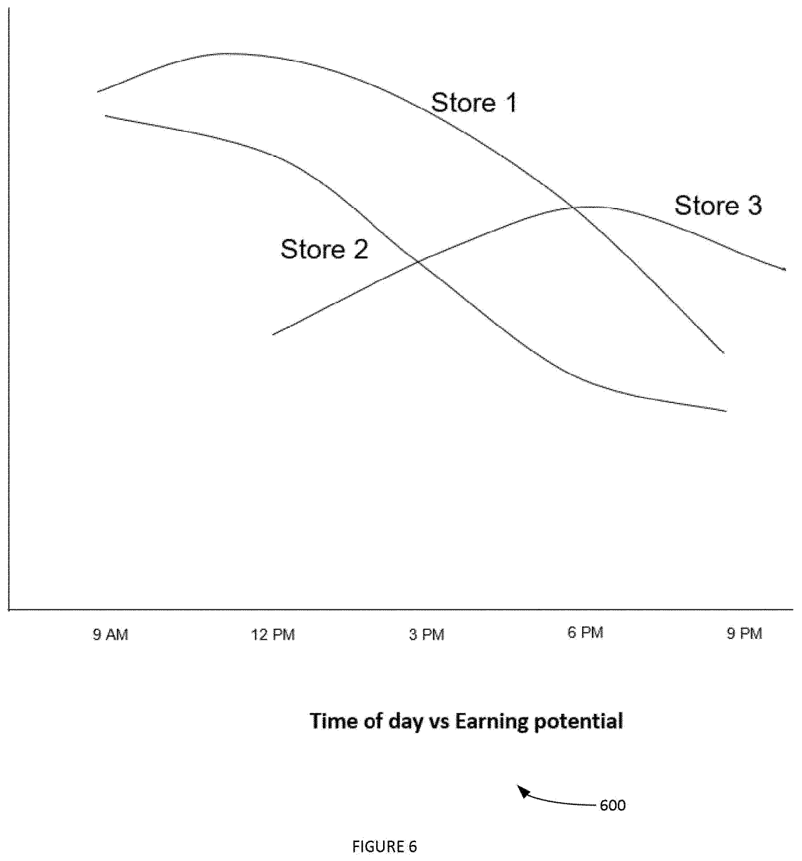

FIG. 6 illustrates an example process 600 illustrating an example graph illustrating time of day vs. earning potential optimizations, according to some embodiments.

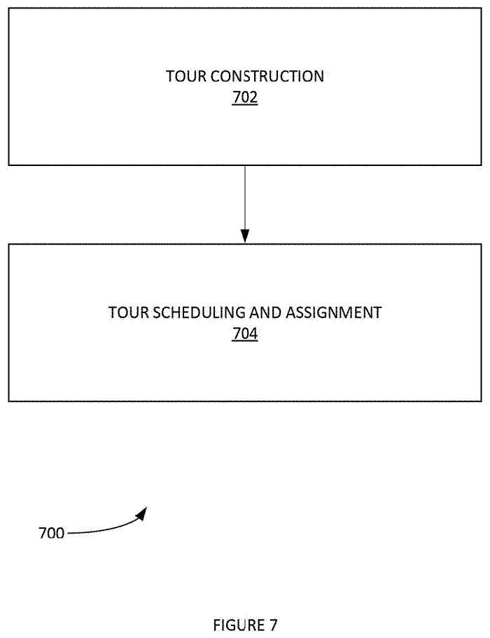

FIG. 7 illustrates an example process 700 for implementing automated salesbeat optimization, according to some embodiments. In step 702, process 700 implements tour construction. Tours for the salesbeats are created using a hybrid heuristic method employing a construction routing heuristic and an integer program. The heuristic generates fast routing solution. In step 704, process 700 can implement tour scheduling and assignment. The tour scheduling is done using a mixed integer program. The mixed integer program assigns tours created to salesman and schedules them on days simultaneously.

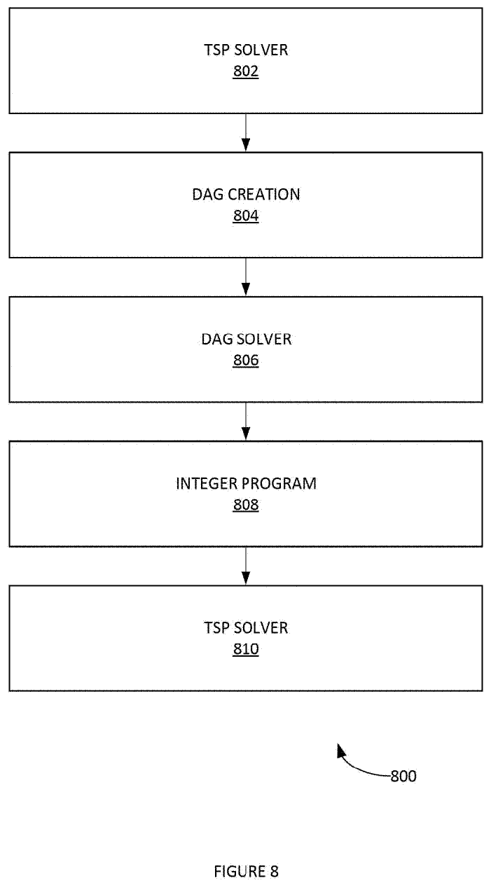

FIG. 8 illustrates an example process 800 for implementing tour construction in an automated salesbeat optimization process, according to some embodiments. Tour construction can use four programs: TSP solver, directed acyclic graph (DAG) creator, DAG solver and an integer program. In step 802, process 800 can implement a TSP solver. In step 804, process 800 can implement DAG creation. In step 806, process 800 can implement a DAG solver. In step 808, process 800 can implement an integer program. In step 810, process 800 can implement a TSP SOLVER.

Process 800 can use the following input data. A basic input to solve for a CVRP problem is batch of all the tasks. A task in the case of permanent journey planning is a store visit.

Process 800 can have the following parameters, for example. Order identifier can be a unique identifier. Store identifier can be an identifier to represent the store/customer to visit. Product_id can be an identifier to represent the product that needs to be sold. Transaction time can be time spent at a store. Previous revenue from store can be input. Coordinates of the store can be input. Miscellaneous parameters and constraints to define the visit can be input. A list of types of vehicles that can be used to complete the tasks. Vehicle parameters can have the following parameters. Vehicle capacity can include the maximum tasks that can be done by the vehicle. Operating hours can be input. Maximum tour length can be input. Count of vehicles available home base can be input. This can be the location where all riders/salesmen begin and end their journey. It can have the following parameters: operating hours; coordinates of the location; etc.

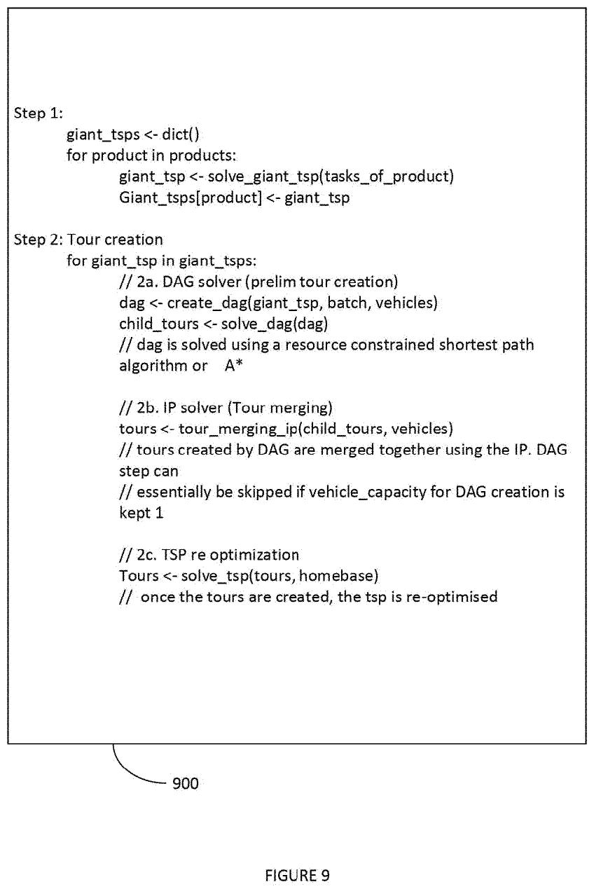

FIG. 9 illustrates an example pseudocode 900 for implementing tour construction in an automated salesbeat optimization process, according to some embodiments.

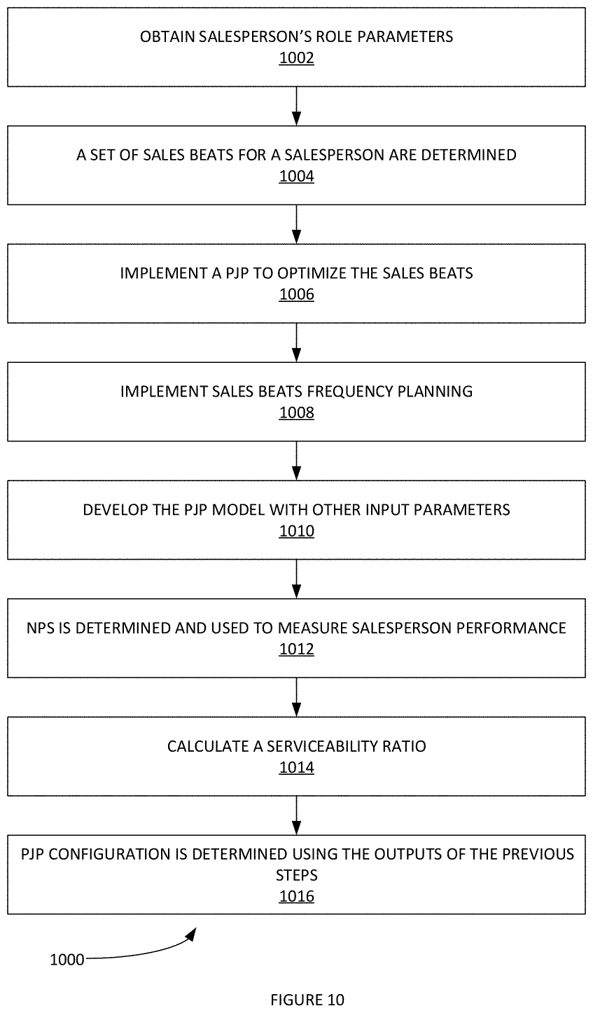

FIG. 10 illustrates an example process 1000 for generating a PJP Configuration, according to some embodiments. In step 1002, the salesperson parameters can be collected. It is noted that the role of the salesperson revolves around the following duties, inter alia: collecting orders for the week (e.g. the salesbeats); collecting payments at the end of the credit cycle and dealing with any return orders (e.g. the delivery beats). These can be further broken down to a set of parameters that a PJP module can use to logically understand and optimize these salesbeat and deliver beat functions. A salesperson role parameter can be to collect orders at existing outlets (e.g. type of outlet; skills of salesperson; number of salespersons; transaction time at each outlet; etc.). A salesperson role parameter can be to sell new products at existing outlets (e.g. an increase in the transaction time at outlets; an increase in the number of visits by salesperson to an outlet; etc.). A salesperson role parameter can be to find new stores (e.g. time availability; salesperson availability (e.g. free salesperson); familiarity of salesperson with the region; relationship building; familiarity of salesperson with the stores; etc.). A salesperson role parameter can be to perform competitor analysis (e.g. this role may be indirectly bettered through optimization of sales routes and freeing up of salespersons).

It is noted that, in some embodiments, a salesbeat can be a geographic cluster of outlets to be visited by a particular salesperson in one day. A tour can be the route taken by the salesperson to service these outlets. In step 1004, a set of salesbeats for a salesperson are determined (e.g. based on output of step 1002).

In step 1006, process 1000 implement a PJP to optimize the salesbeats through decreasing distance travelled, increasing transaction time etc. while keeping the working hours of the salesperson constant.

In step 1008, process 1000 can implement salesbeats frequency planning. Step 1008 can use the following constraints/values, inter alia: ideal spacing; decrease mirror spacing; decrease non-mirror spacing; other factors; etc.

Ideal spacing can deal spacing is the scheduling the visits of salespersons based on a pre-set frequency. This pre-set frequency is determined by the client (or an administrator). This can be represented as N+1, N+2, N+3 etc. In one example, a spacing of N+3, where N is Monday can mean that the salesperson would visit that outlet on Monday, then again three days later on Thursday and so on).

Mirror spacing can mean that multiple salesperson(s) selling the same SKU(s) for the same parent brand may visit the same outlet(s) on the same day(s). Inefficient route planning and overlapping of sales routes/outlets visited by salesperson can result in mirror spacing. Mirror type of spacing can increase operational costs and lower the productivity of the salesperson(s). In this way, it is also detrimental to building familiarity.

Non-mirror spacing can mean that the that multiple salesperson(s) selling the same SKU(s) for the same Parent brand would visit the same outlet(s) on the different days. A major disadvantage of this kind of spacing is that it reduces the familiarity of the salesperson with the outlet. For salesperson-outlet relationships to flourish, it is suggested that the same salesperson be sent to the outlet for every round of demand distribution.

In step 1010, process 1000 can develop the PJP model with other input parameters. Apart from the input parameters already specified in this document, the PJP model uses inputs on an outlet level, salesperson level and configuration level. The outlet input parameter can include, inter alia: time windows for delivery, days open, priority. The salesperson input parameter can include, inter alia: working hours, days working, total distance travelled, travel time, mode of transportation, skills (e.g. expertise in type of product), sales performance (NPS). The configuration input parameter can include, inter alia: start node, end node, market preference, zone-based routing.

In step 1012, the net promoter score (NPS) can be determined and used to measure salesperson performance. NPS is a management tool to measure the loyalty of an outlet to the parent company/salesperson. The following factors are considered while determining the NPS for a salesperson, inter alia: new outlet, new sales revenue, new sales in line items, new sales in lines, total revenue, iterate (e.g. visits converted to sales).

In step 1014, process 1000 can calculate a serviceability ratio. The serviceability ratio is the ability of a salesperson to iterate or convert a visit into a sale. The serviceability ratio is related to the transaction time spent at the store, making the sales to the outlet. The serviceability ratio can be calculated as:

$$Serviceability Ratio = \frac{Transaction Time}{Transaction Time + Travel Time}$$

A higher Serviceability ratio is preferred. This can be achieved by increasing the transaction time while decreasing the travel time through optimization.

In step 1016, the PJP configuration is determined using the outputs of the previous steps. The PJP configuration sets the basis for expectation management (e.g. the planner's capabilities with respect to optimization of distance, number of salespersons, time etc.). Setting the expectation of the client/figuring out the configuration is done by Locus's engagement management team through defining a use case. A configuration can be client specific and unique combination of optimizable parameters of the module. Process 1000 can use revenue parameters (e.g. average time spent, free time, familiarity, frequency of visits etc.) to be increased. Process 1000 can use cost parameters (e.g. distance, number of salespersons, time spent etc.) to be reduced through the application of PJP. A PJP configuration can also account for fairness in the system for the salespersons based on client specifications, inter alia: fairness in revenue, fairness in number of outlets, fairness in time, fairness in distance, etc.

The PJP configuration generated by process 1000 can be used to, inter alia: reveal an efficient mechanism for order collection; allow for visual merchandising of products and competitor analysis as indirect benefits of PJP planning; provide accurate service levels at each outlet (e.g. with provisions to match the skills of the salesperson with the requirement of the outlet, and allocation of outlets based on the familiarity of the salesperson.); provide optimized beat size and intelligently designed beats; provide an efficient sequencing of outlets to reduce travel time, reduce distance travelled, reduce beat length and eliminate unnecessary back-and-forth trips; decrease salesperson fatigue and improved salesperson productivity without increasing working hours (e.g. through prevention of underutilization); enable access to a set of geocoding algorithms to convert otherwise malformed addresses to latitude-longitude; provide an optimized transaction times per outlet for increased serviceability ratio (e.g. through the use of PJP, there arises an opportunity to increase in service time spent at each outlet by a salesperson through reduction in travel time, reduction in overlapping routes and removal of mirror beats.); provide a reduction in operational costs; provide optimization of volume sold (e.g. in line with the capacity of the distribution cycle); take the needs for multiple stakeholders (e.g. parent company, salesperson or outlets) into account while generating beats.

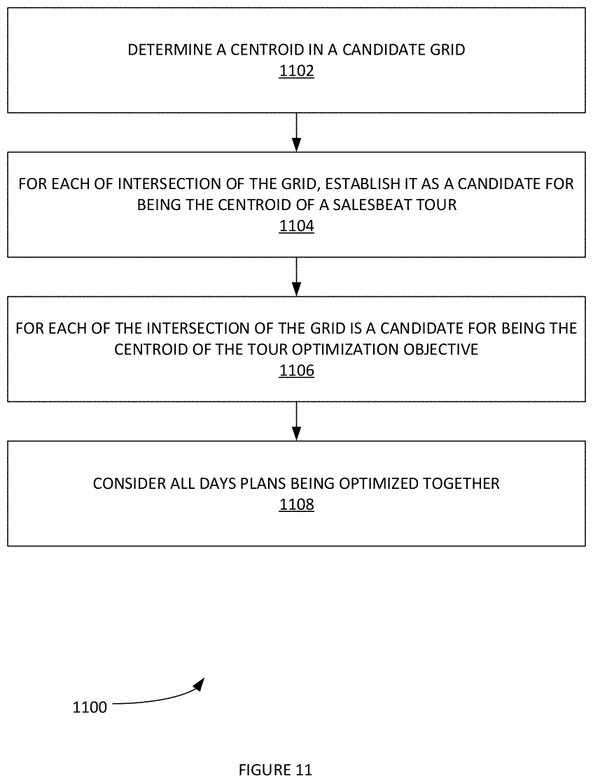

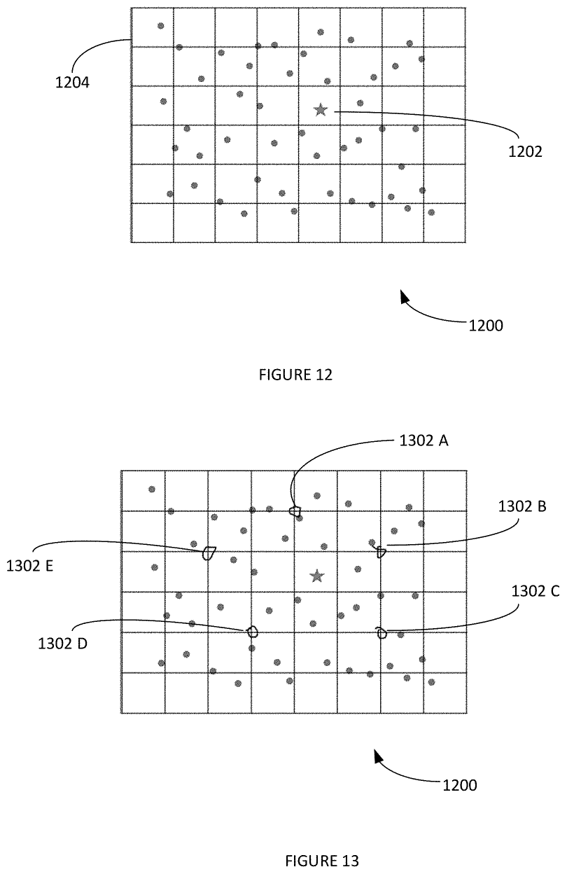

FIG. 11 and FIGS. 12-15 illustrate an example process 1100 for PJP modelling, according to some embodiments. In step 1102, process 1100 can determine a centroid in a candidate grid. The candidates can be sales representative customers. FIG. 12 illustrates an example of a 1200 dropped centroid in an example candidate grid. Process 1100 can provide a set of candidate centroids and then determine an optimization to solve the compactness problem. It is noted that compactness is a property that generalizes the notion of a subset of Euclidean space being closed (e.g. containing all its limit points) and bounded (e.g. having all its points lie within some fixed distance of each other). The candidates are represented by dots.

In step 1104, process 1100 can, for each of intersection of the grid, establish it as a candidate for being the centroid of a salesbeat tour. For example, FIG. 13 illustrates grid 1200 with centroid candidates 1302 A-E.

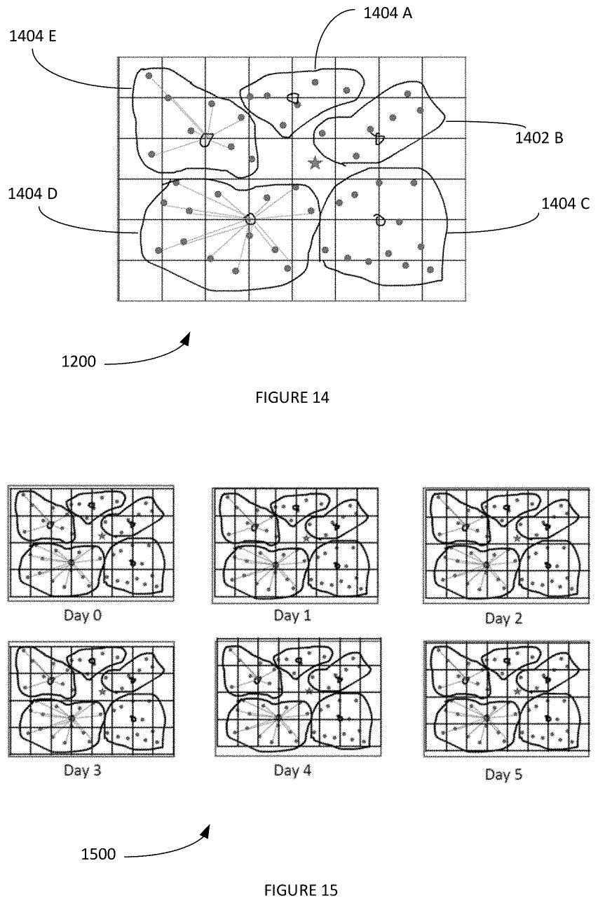

In step 1106, process 1100 can, for each of the intersection of the grid is a candidate for being the centroid of the tour optimization objective. Process 1100 can minimize the sum of all the provided lines. The centroids can be any of the grid points. Process 1100 can choose the set of grid points that minimize the sum of all these blue lines. In this way, process 1100 can provide optimal clustering based on this objective. FIG. 14 illustrates an example of step 1106 being implemented in grid 1200.

In step 1108, process 1100 can consider all days plans being optimized together. Process 1100 can find the set of grid points for each day such the sum of lengths of blue lines is the minimum summed overall days and all clusters. This is shown in 1500 of FIG. 15.

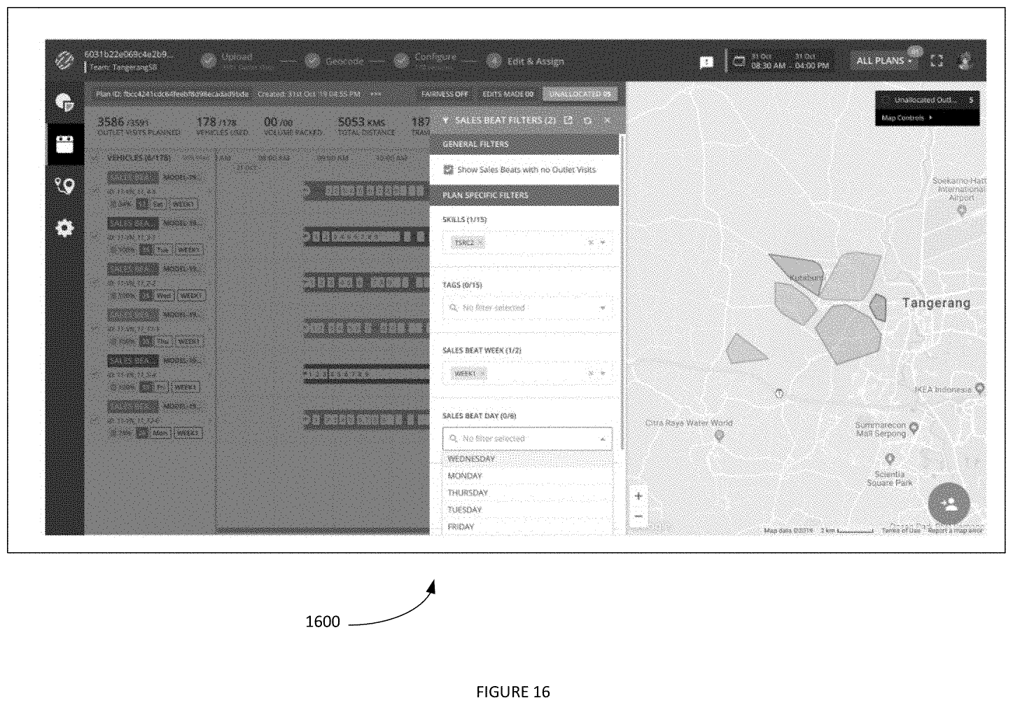

FIG. 16 illustrates an example PJP planning screen shot 1600, according to some embodiments.

Mixed Integer Programming

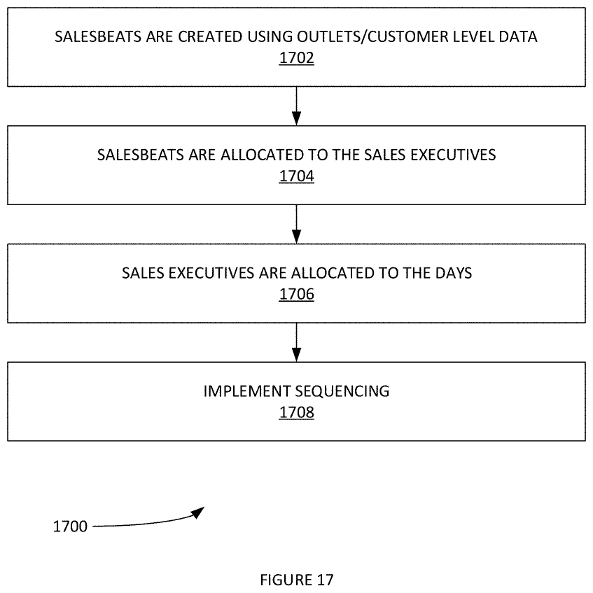

FIG. 17 illustrates an example process 1700 for utilizing Mixed Integer Programming (MIP) for PJP, according to some embodiments. Process 1700 can allocate the beat, sales executive and days simultaneously. In step 1702, salesbeats are created using outlets/customer level data. In step 1704, salesbeats are allocated to the sales executives (e.g. salespersons, etc.). IN step 1706, the sales executives are allocated to the days. In step 1708, process 1700 implements sequencing. Sequencing of outlets within the salesbeats established is done through the a CVRP/Dispatcher Algorithm. This can optimize on distance, time windows of the Sales Executives, time slots of the Outlet, Revenue/priority and other business constraints.

It is noted that the value add in determining the salesbeat structure is much greater than that of sequencing to the client. The PJP product can optimize by reducing loss in revenue and loss in priority while increasing familiarity and affinity. Each client's problem can use a solution based on client specific objectives and constraints. Standardized use-cases can be established over time.

Process 1700 can use hard constraints. A hard constraint is one where the PJP process works towards meeting said constraints at the cost of the optimality of a solution. These constraints are treated as mandatory. If this constraint cannot be met, it will be left unallocated.

Process 1700 can use soft constraints. A soft constraint is one where the PJP process may try not to breach (e.g. it can provide a solution where the soft constraints are maximized). These constraints are not treated as mandatory, however. In the event a soft constraint can't be met, the PJP algorithm can still allocate the tasks that don't meet the constraint.

Conclusion

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

1. A computerized method of automated solution for periodic journey planning comprising:
creating a set of salesbeats using a set of outlet data and a set of customer level data;
allocating each of the salesbeats to one or more sales executives, wherein a salesbeat comprises a plan that defines who to visit; when to visit; an identity of a sales executives to send and a day level route plan made for field sales/marketing personnel to make visits to a number of stores at a predefined frequency;
allocating the sales executives are allocated to a specified set of days; and
implements sequencing of outlets within the salesbeats established using a capacitated vehicle routing problem (CVRP) algorithm such that a distance traveled and a time window of the salesbeat is optimized for the sales executives.

2. The computerized method of claim 1, wherein the salesbeat further comprises a set of company priorities on a stores category.

3. The computerized method of claim 2, wherein the salesbeat further comprises a permanent journey plan.

4. The computerized method of claim 3, wherein the CVRP algorithm optimizes a set of time slots of the outlet.

5. The computerized method of claim 3, wherein the CVRP algorithm optimizes a revenue constraints of an enterprise employing the sales executive.
